(19) United States
(12) Patent Application Publication
(10) Pub. No.: US 2015/0015144 A1
(43) Pub. Date: Jan. 15, 2015

(54) HIGH EFFICIENCY CERAMIC LAMP

(71) Applicant: General Electric Company, Schenectady, NY (US)

(72) Inventors: Timothy David RUSSELL, North Ridgeville, OH (US); James A. LEONARD, Shaker Heights, OH (US); Nicholas James BARBUTO, Cleveland, OH (US); Corey Justin CHECKAN, Ravenna, OH (US)

(21) Appl. No.: 13/937,598

(22) Filed: Jul. 9, 2013

(51) Int. Cl. H01J 61/12

(52) U.S. Cl. CPC H01J 61/125
USPC 315/111.01; 313/640

(57) ABSTRACT

Embodiments provide a ceramic metal halide (CMH) lamp and methods for making the same that provide or achieve, during lamp operation, a correlated color temperature (CCT) greater than 5000 K, a color rendering index (CRI) of 85 or greater, a lumen maintenance percentage (LM %) greater than 90%, and a life of at least 15,000 hours.

### FIELD OF THE INVENTION

The present disclosure relates to a high efficiency discharge lamp. In particular, the present disclosure relates to a high efficiency ceramic metal halide (CMH) lamp with a source of available oxygen in the vessel that, during lamp operation, achieves and maintains high lumen maintenance, a correlated color temperature greater than 5000 K, and a color rending index of at least 85.

### BACKGROUND OF THE INVENTION

In general, high intensity discharge (HID) lamps produce light by ionizing a vapor fill material sealed within a discharge vessel that includes two electrodes when an electric arc passes between the two electrodes. The fill material may include a mixture of rare gases, metal halides and mercury. The discharge vessel is typically a transparent, or at least translucent, container that maintains a pressure of the energized fill material while allowing the emitted light to pass there through. The fill material or “dose” emits a desired spectral energy distribution in response to being excited by the electric arc generated between the electrodes.

A number of characteristics or metrics may be considered regarding the operation of a HID lamp. Some operational characteristics include lamp life, light efficiency, color rendering, and color temperature. A lamp providing a combination of reliable and consistent bright light and color rendering, high energy efficiency, and long life that can be used in a variety of applications is greatly desired. In some aspects, lamps have been provided that satisfy some, but not all, of the desired of features of reliable and consistently bright light and color rendering, energy efficiency, long life, and versatility of use.

Some prior quartz metal halide (QMH) technology lamps have been reported to provide a lamp having a CRI greater than 90. However, such QMH lamps do not operate with a tungsten cleaning cycle. Accordingly, the benefits provided by a tungsten cleaning cycle, such as consistent light rendering throughout the lifespan of the lamp and high efficiency, are lacking in such lamps. Such lamps tend to have a light output that diminishes over time due to a blackening or darkening of the discharge vessel walls from tungsten being transported from the electrode and deposited on the walls of the discharge vessel. Additionally, some prior QMH lamps have been reported to operate at 5000 K-6000 K and/or have a CRI greater than 90. However, such QMH lamps have an energy efficiency of less than 80 lumens per watt (LPW), as well as a lifespan on the order of about 10,000 hours.

Accordingly, there exists a need for a discharge lamp that achieves good CCT, CRI and LM in a lamp having a long lifespan.

### SUMMARY OF THE INVENTION

Disclosed are apparatus and methods for providing a ceramic metal halide (CMH) lamp and methods for making the same that provide or achieve, during lamp operation, a correlated color temperature (CCT) greater than 5000 K, a color rendering index (CRI) of 85 or greater, a lumen maintenance percentage (LM %) greater than 90%, and a life of at least 15,000 hours. In accordance with the present disclosure, some embodiments include a ceramic metal halide lamp including a discharge vessel formed of a ceramic material, a tungsten electrode extending into the discharge vessel to energize a fill when an electric current is applied to thereto, and an ionizable fill sealed within the discharge vessel. The composition of the fill includes, to achieve the desired operational characteristics, a halide component comprising a rare earth halide selected from the group consisting of praseodymium halides, cerium halides, lanthanum halides, neodymium halides, samarium halides, gadolinium halides, and combinations thereof that are compatible with a tungsten wall cleaning cycle; a source of available oxygen in the discharge vessel combining, during lamp operation, to achieve and maintain the tungsten wall cleaning cycle; at least one of manganese and gallium; an amount of cesium iodide; and an alkaline earth metal halide to achieve a lamp life of at least 15000 hours.

In some aspects, the present disclosure includes a method of operating a ceramic metal halide lamp comprising providing a ceramic metal halide lamp that includes a discharge vessel formed of a ceramic material, a tungsten electrode extending into the discharge vessel to energize a fill when an electric current is applied thereto, and an ionizable fill sealed within the discharge vessel. The fill includes, at least in part to achieve the desired operational characteristics, a halide component comprising a rare earth halide selected from the group consisting of praseodymium halides, cerium halides, lanthanum halides, neodymium halides, samarium halides, gadolinium halides, and combinations thereof that are compatible with a tungsten wall cleaning cycle; a source of available oxygen in the discharge vessel combining, during lamp operation, to achieve and maintain the tungsten wall cleaning cycle; at least one of manganese and gallium; an amount of cesium iodide; and an alkaline earth metal halide to achieve a lamp life of at least 15,000 hours.

### BRIEF DESCRIPTION OF THE DRAWINGS

Aspects and/or features of the present disclosure and many of their attendant benefits and/or advantages will become more readily apparent and appreciated by reference to the detailed description when taken in conjunction with the accompanying drawings, which may not be drawn to scale.

FIG. 1 is an illustrative depiction of a CMH lamp, in accordance with some embodiments herein;

FIG. 2 is an illustrative plot of the effect of different rare earth halides on the operational characteristics of a CMH lamp, in accordance with some embodiments herein;

FIG. 3 is an illustrative plot of the effect of manganese on the operational characteristics of a CMH lamp, in accordance with some embodiments herein;

FIG. 4 is an illustrative plot of the effect of calcium and strontium on the operational characteristics of a CMH lamp, in accordance with some embodiments herein; and

FIG. 5 is an illustrative plot of the effect of cesium on the operational characteristics of a CMH lamp, in accordance with some embodiments herein.

### DETAILED DESCRIPTION

Disclosed herein are ceramic metal halide (CMH) lamps and methods for making the same that provide or achieve, during lamp operation, a combination of different operational characteristics. A brief description of some of the characteristics discussed herein will now be presented. The present disclosure will discuss the embodiments herein in a manner consistent with the following descriptions.

Correlated color temperature (CCT) is a measure of the warmth or coolness of the color emitted by a lamp and is measured in units of degrees Kelvin. For example, a lamp having a CCT of 3000 K has about the same color as an ideal blackbody glowing at that temperature. A lower CCT rated lamp will have a more yellow tint and a lamp with a higher CCT rating (e.g., >5000 K) will have more of a blue color or tint. In accordance with aspects of the present disclosure, embodiments of some CMH lamps herein achieve, during operation, a CCT of at least 5000 K. In some embodiments, Applicant has realized CMH lamps with a CCT of at least 6000 K, and even greater.

Color rendering index (CRI) is a measure of the ability of a lamp or other light source to accurately render an object's color in comparison with a natural light source. CRI is measured on a scale of 1-100, where 100 is the ideal. In accordance with aspects of the present disclosure, embodiments of some CMH lamps herein achieve, during operation, a CRI of at least 80. In some embodiments, CMH lamps herein achieve a CRI of at least 85, and even greater than 90.

Lumen maintenance (LM %) is a measure of the deterioration in the amount of light that is emitted from a lamp over time. Lumen maintenance is typically measured as a percentage. A lamp with a higher LM % emits a consistent amount of light over a greater portion of its lifetime than a lamp with a lower LM %. For example, a lamp with a LM % of 90% emits 90% of its initial or original light capability after 40% of its lifespan. Conversely, a lamp with a lower LM % (e.g., LM %<50%) will lose as much as 50% or more of its ability to emit light over time. In accordance with aspects of the present disclosure, embodiments of some CMH lamps herein achieve, during operation, a LM % of at least 85%. In some embodiments, CMH lamps with a LM % of at least 90% have been realized.

Efficacy is a measure, expressed in lumens per watt (LPW), that represents the efficiency of a lamp or other light source. In accordance with aspects of the present disclosure, embodiments of some CMH lamps herein achieve, during operation, a efficacy or efficiency of at least 80 LPW.

In some embodiments, a CMH lamp in accord with the present disclosure achieves a CCT greater than 5000K, a CRI of 85 or greater, a LM % greater than 90%, and a life of at least 15,000 hours. The CMH lamp of the present disclosure, in some embodiments, achieves all of these stated characteristics simultaneously and in combination with each other. That is, some embodiments of CMH lamps herein operate with all of the features of a CCT greater than 5000K, a CRI of 85 or greater, a LM % greater than 90%, and a life of at least 15,000 hours.

CMH lamps may be used in a wide variety of different applications, including outdoors and indoors. In some aspects, CMH lamps may be used in applications where a high level of brightness at relatively low cost is desired. CMH lamps typically operate at a high temperature and a high pressure over a prolonged period of time. Also, due to their usage and cost, it is desirable that these lamps have a relatively long useful live wherein they produce a reliable brightness and color level of light so as to, for example, reduce labor costs associated with the installation and maintenance of the lamps.

In another aspect, a method of forming a lamp includes providing a discharge vessel, providing tungsten electrodes that extend into the discharge vessel, and sealing an ionizable fill within the vessel. The fill includes a buffer gas, optionally metallic mercury, and a halide component including a rare earth halide selected from the group consisting of praseodymium halides, cerium halides, lanthanum halides, neodymium halides, samarium halides, gadolinium halides, and combinations thereof. A source of available oxygen is sealed in the discharge vessel. The source of available oxygen is present in an amount such that the solubility of tungsten species in the fill during lamp operation is compatible with a tungsten wall cleaning cycle.

Aspects of an embodiment herein relate to a fill for a lamp that is formulated to, in part, promote a tungsten regeneration cycle or tungsten wall cleaning cycle by enabling a higher solubility of tungsten species adjacent a wall of the lamp where deposition would otherwise occur, as opposed to at the electrode even though the electrode operates at a substantially higher temperature than the wall.

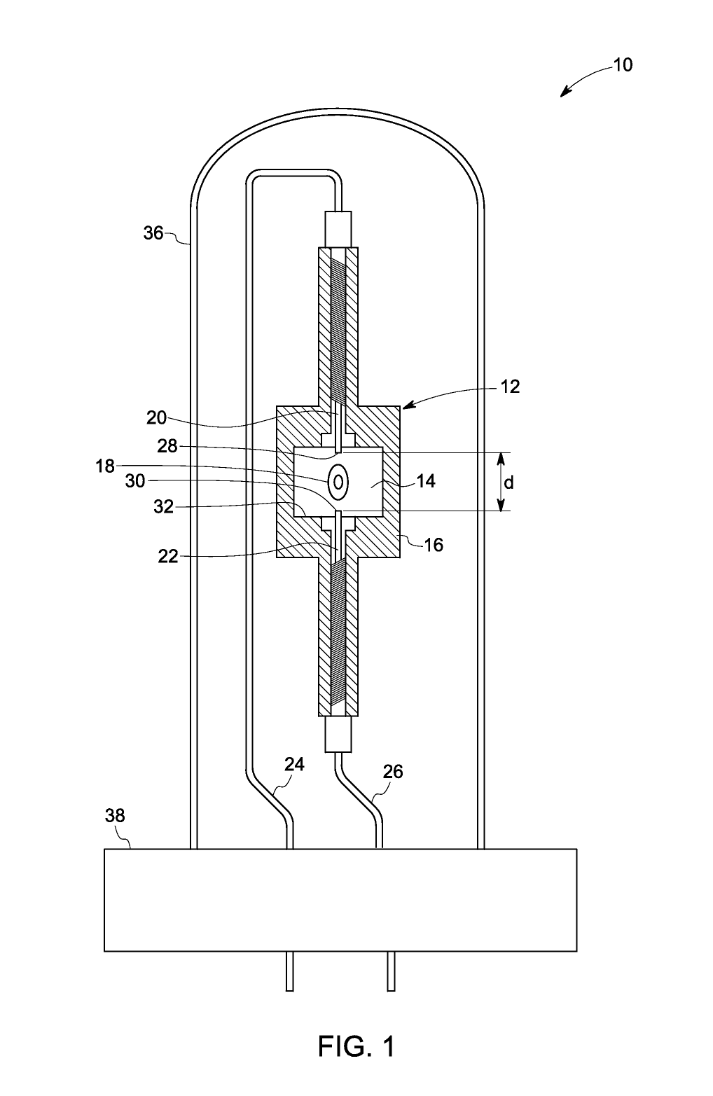

FIG. 1 is a cross-sectional view of a CMH lamp 10. The lamp includes a discharge vessel or arc tube 12 that defines an interior chamber 14. Discharge vessel 12 has a wall 16 that may be formed of a ceramic material, such as alumina. An ionizable fill 18 is sealed within an interior chamber 14. Also positioned within discharge vessel 12 are tungsten electrodes 20 and 22. In FIG. 1, the tungsten electrodes are positioned at opposite ends of discharge vessel 12 to energize the fill when an electric current is applied thereto during operation of lamp 10. Electrodes 20 and 22 are typically supplied with an alternating electric current via conductors 24, 26. Tips 28, 30 of the electrodes 20, 22 are spaced apart by a distance d that defines the “arc gap”. When CMH lamp 10 is powered during lamp operation, a voltage difference is created between the electrodes 20 and 22. This voltage difference generates an electrical arc across the gap between tips 28, 30 of the electrodes. The arc produces a plasma discharge in the region between electrode tips 28, 30, thereby generating visible light that that is transmitted out of the chamber 14 and through wall 16.

The electrodes 20, 22 become heated during lamp operation and tungsten tends to vaporize from the tips 28, 30. Some of the vaporized tungsten may typically tend to deposit on an interior surface 32 of wall 16. Absent a tungsten regeneration cycle, the deposited tungsten may result in a blackening of the wall and a corresponding reduction in the transmission of the visible light.

In some aspects electrodes 20, 22 may be formed from pure tungsten (e.g., greater than 99% pure tungsten). However, it is contemplated that the electrodes may have a lower tungsten content such as, for example, about 50% to about at least 95% tungsten.

In the example of FIG. 1, arc tube 12 is surrounded by an outer bulb 36 that has a lamp cap 38 at one end through which the lamp is connected to a source of power (not shown). Bulb 36 may be formed of glass or other suitable material. The space between arc tube 12 and outer bulb 36 may be evacuated.

The ionizable fill 18 includes a buffer gas, optionally mercury (Hg), a halide component, and a source of available oxygen, which may be present as a solid oxide. In some embodiments, the fill may include a source of available halogen. The components of the fill 18 and their respective amounts are selected to provide a higher solubility of tungsten species at the wall surface 32 for reaction with any tungsten deposited there. In operation, electrodes 20, 22 produce an arc between electrode tips 28, 30 that ionizes fill 18 to produce a plasma in the discharge space.

The emission characteristics of the light produced thereby are primarily based on the constituents of the fill material, the voltage across the electrodes, the temperature distribution of the chamber, the pressure in the chamber, and the geometry of the chamber. In the following description of the fill, the amounts of the components refer to the amounts initially sealed in the discharge vessel, i.e., before operation of the lamp, unless otherwise noted.

The halide component may be present at from about 4 to about 30 mg/cm³ of arc tube volume, e.g., about 5-15 mg/cm³. A ratio of halide dose to mercury can be, for example, from about 1:3 to about 15:1, expressed by weight. The halide(s) in the halide component can each be selected from chlorides, bromides, iodides and combinations thereof. In one embodiment, the halides are all iodides. Iodides tend to provide longer lamp life, as corrosion of the arc tube and/or electrodes is lower with iodide components in the fill than with otherwise similar chloride or bromide components. The halide compounds usually will represent stoichiometric relationships.

In one aspect of some embodiments herein, a lamp includes a discharge vessel having an ionizable filled within the discharge vessel. Tungsten electrodes extend into the discharge vessel. The fill includes a buffer gas, optionally metallic mercury, a halide component including a rare earth halide selected from the group consisting of praseodymium halides, cerium halides, lanthanum halides, neodymium halides, samarium halides, gadolinium halides, and combinations thereof. A source of available oxygen is present in the discharge vessel. The rare earth halide is present in an amount such that, during lamp operation, in combination with the source of available oxygen, maintains a difference in solubility for tungsten species present in a vapor phase between a wall of the discharge vessel and at least a portion of at least one of the electrodes (i.e., compatible with a tungsten wall cleaning cycle).

In another aspect, a lamp includes a discharge vessel. Tungsten electrodes extend into the discharge vessel. An ionizable fill is sealed within the vessel. The fill includes a buffer gas, optionally mercury, and a cerium halide. The fill also includes at least one of the group consisting of a) an alkali metal halide other than sodium halide; b) an alkaline earth metal halide, other than magnesium, and c) a halide of an element selected from indium. The lamp fill is free of halides of holmium, thulium, dysprosium, erbium, lutetium, yttrium, and ytterbium, terbium, scandium, and magnesium. Oxygen or an available oxygen source, such as for example, tungsten oxide is sealed in the vessel in a sufficient amount to maintain a concentration of WO₂X₂ in a vapor phase in the fill during lamp operation of at least 1×10⁻⁹ μmol/cm³.

The rare earth halide of the halide component is one that is selected in type and concentration such that it does not form a stable oxide by reactions with the optional source of oxygen, i.e., forms an unstable oxide. As understood herein, it permits available oxygen to exist in the fill during lamp operation. Some exemplary rare earth halides that form unstable oxides include halides of lanthanum (La), praseodymium (Pr), neodymium (Nd), samarium (Sm), cerium (Ce), gadolinium (Gd), and combinations thereof. The rare earth halide(s) of the fill can have the general form REX₃, where RE is selected from La, Pr, Nd, Sm, Gd, and Ce, and X is selected from Cl, Br, and I, and combinations thereof. The rare earth halide may be present in the fill at a total concentration of, for example, from about 4 to about 10 μmol/cm³.

An exemplary rare earth halide from this group is praseodymium halide, which may be present at a molar concentration of at least 16% of the halides in the fill (e.g., at least about 28 mol % of the halides in the fill). In one embodiment, only rare earth halides from this limited group of rare earth halides are present in the fill. The lamp fill is thus free of other rare earth halides (i.e., all other rare earth halides are present in a total amount of no more than about 0.1 μmol/cm³. In particular, the fill is free of halides of the following rare earth elements: terbium, dysprosium, holmium, thulium, erbium, ytterbium, lutetium, and yttrium. Other halides that form stable oxides are also not present in the fill, such as, for example, scandium halides and magnesium halides.

In some aspects, a CMH lamp herein may operate with a high CCT of at least 5000 K to greater than 6000 K. The metal halide in such lamps includes praseodymium (Pr). In some embodiments, the metal halide may include PrX₃, MnX₂, CsX, CaX₂, GaX₃, and others. In accordance with some of the desired characteristics for the CMH lamps herein, the use of, for example, manganese, cesium, and gallium metal halides provides for the achievement of high CCT (e.g., >5000 K) and high LM % (e.g., >90%), as discussed herein.

In some aspects, the fill may include a halide such as PrX₃, where the fill is free of sodium iodide (NaI) and thallium iodide (TII). That is, some embodiments of CMH lamps herein do not include or use any NaI and TII in the fill.

In some aspects, halides compatible with some embodiments of the CMH lamps herein may include metal halides that provide strong blue emission lines. Some such halides include, for example, vanadium (V), lead (Pb), indium (In), barium (Ba), and strontium (Sr). Some further embodiments may include other alkaline earth halides such as, for example, SrX2 and BaX2, where X is defined as a halogen I, Br, Cl. Further still, metal halides compatible with some embodiments herein may include, for example, arc fattening halides such as CsX, KX, and others, where X is a halogen I, Br, Cl.

The alkali metal halide, where present, may be selected from lithium (Li), potassium (K), and cesium (Cs) halides, and combinations thereof In one specific embodiment, the alkali metal halide includes cesium halide. The alkali metal halide(s) of the fill can have the general form AX, where A is selected from Li, K, and Cs, and X is as defined above, and combinations thereof. The alkali metal halide may be present in the fill at a total concentration of, for example, from about 5 to about 10 μmol/cm³. In some embodiments where GdX₃ is used, the alkali metal halide may then include NaX.

The alkaline earth metal halide, where present, may be selected from calcium (Ca), barium (Ba), and strontium (Sr) halides, and combinations thereof. The alkaline earth metal halide(s) of the fill can have the general form MX₂, where M is selected from Ca, Ba, and Sr, and X is as defined above, and combinations thereof. In one specific embodiment, the alkaline earth metal halide includes calcium halide. The alkaline earth metal halide may be present in the fill at a total concentration of, for example, from about 5 to about 15 μmol/cm³. In another embodiment, the fill is free of calcium halide.

The source of available oxygen is one that, under the lamp operating conditions, makes oxygen available for reaction with other fill components to form WO₂X₂. The source of available oxygen gas may be an oxide that is unstable under lamp operating temperatures, such as an oxide of tungsten, free oxygen gas (O₂), water, molybdenum oxide, mercury oxide, or combination thereof. The oxide of tungsten may have the general formula WOₙXₘ, where n is at least 1, m can be 0, and X is as defined above. Exemplary tungsten oxides include WO₃, WO₂, and tungsten oxyhalides, such as WO₂I₂. The source of available oxygen may be present in the fill expressed in terms of its O₂ content at, for example, from about 0.1 μmol/cm³, e.g., from 0.2-3 μmol/cm³ and in one embodiment, from 0.2-2.0 μmol/cm³.

In some aspects, dosing of the fill may be accomplished using CeO₂, CsI—WO₃, WO₃, and MoO₃. However, the oxygen may be introduced using O, CO₂, and other materials, including but not limited to those specifically stated hereinabove. In some embodiments, the particular manner of how the fill is dosed with oxygen is not particularly important, whereas the amount of oxygen available is a key factor.

It will be appreciated that certain oxides do not decompose readily to form available oxygen under lamp operating conditions, such as cerium sesquioxide (Ce₂O₃) and calcium oxide, and thus do not tend to act effectively as sources of oxygen. In general, most oxides of rare earth elements are not suitable sources of available oxygen as they are stable at lamp operating temperatures.

Exemplary fill components comprising the fill for CMH lamp embodiments herein have been disclosed throughout the present disclosure. Table 1 below provides a concise tabular listing of the different materials realized to achieve and provide the desired CMH lamps characteristics of CCT>5000 K, CRI>85, LM %>90%, and life>15,000 hours.

TABLE 1

| | | | | Alkaline |
|---|---|---|---|---|
| | Rare | Alkali | Blue | Earth |
| | Earth | Metal | Emitter | Metal |
| Fill | LaX3 | LiX | MnX2 | CaX2 |
| Materials | CeX3 | KX | GaX2 | SrX2 |
| | PrX3 | RbX | | BaX2 |
| | NdX3 | CsX | | |
| | SmX3 | | | |
| | GdX3 | | | |

Exemplary fill compositions for CMH lamp embodiments herein may be formulated as indicated in Table 2. As illustrated in Table 2, a range of amounts for different fill composite components are listed, that provide for the desired CMH lamps characteristics of CCT>5000 K, CRI>90. LM %>90%, and life>15,000 hours.

TABLE 2
Molar % Limits of Dose Material

| | Rare | Alkali | Blue | Alkaline |
|---|---|---|---|---|
| | Earth | Metal | Emitter | Earth Metal |
| Mole % | PrI3 | CsI | MnI2 | CaI2 |
| Min | 16% | 23% | 4% | 30% |
| Max | 34% | 35% | 17% | 50% |
| Other | NdI3 | KI | MnBr2 | CaBr2 |
| Materials | LaI3 | RbI | GaI2 | SrI2 |
| Valid for | GdI3 | LiI | GaBr2 | SrBr2 |
| Design | PrBr3 | CsBr | | BaI2 |
| | NdBr3 | KBr | | SrBr2 |
| | LaBr3 | RbBr | | |
| | GdBr3 | LiBr | | |

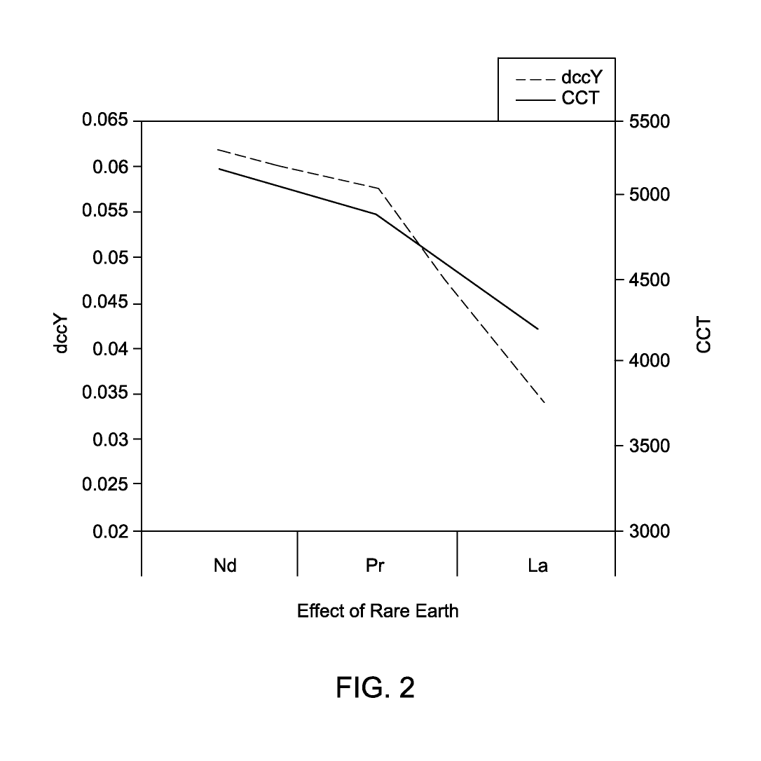

Referring to FIG. 2, an illustrative plot of the effects of different rare earth halides on the operational characteristics of a CMH lamp provided in accordance with other aspects herein is shown. In particular, FIG. 2 plots the CCT for Nd, Pr, and La. As illustrated, use of the rare earths Pr and Nd yields a CCT>5000 K. This is in contrast to La that exhibits a CCT of <4000 K to about 4750 K. FIG. 2 also shows a plot of the dCCy for the same rare earth materials. The dCCy measurement is the difference in chromaticity of the color point on the Y axis (CCY), from that of a standard black body curve.

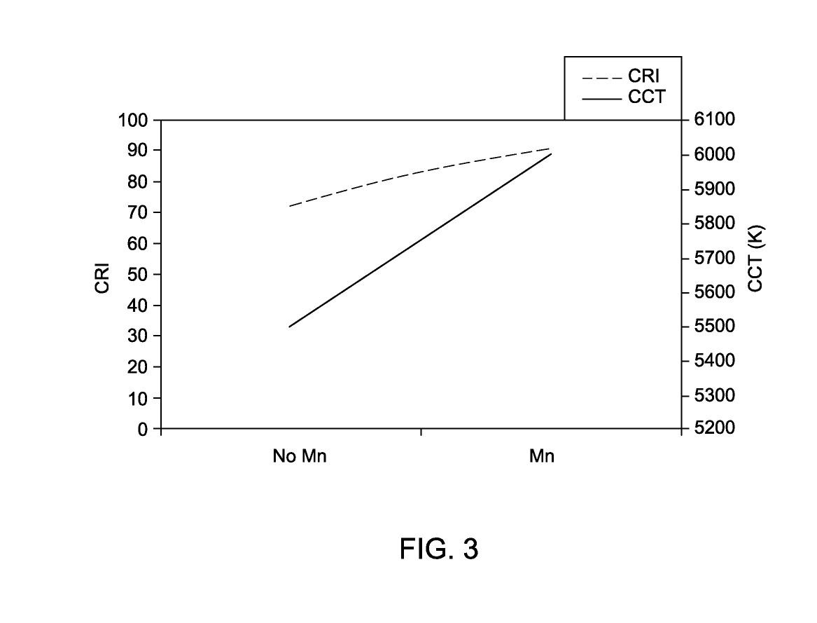

FIG. 3 is an illustrative plot of the effect of manganese (Mn) on the operational characteristics of a CMH lamp, in accordance with some embodiments herein. In particular, FIG. 3 plots the CCT for a fill herein without Mn and a fill including Mn in an amount otherwise specified herein. As illustrated, with the inclusion of Mn a CMH lamp is able to achieve a CRI of about at least 80, and even greater than 90. As shown, a CMH lamp without the addition of Mn achieves a CRI of about no more than about 80. FIG. 3 also shows a plot of the CCT for Mn. The CCT measurement for the CMH lamp with Mn is at least 5700 K to about greater than 6000 K. The CCT measurement for the CMH lamp without Mn is less than about 5700 K.

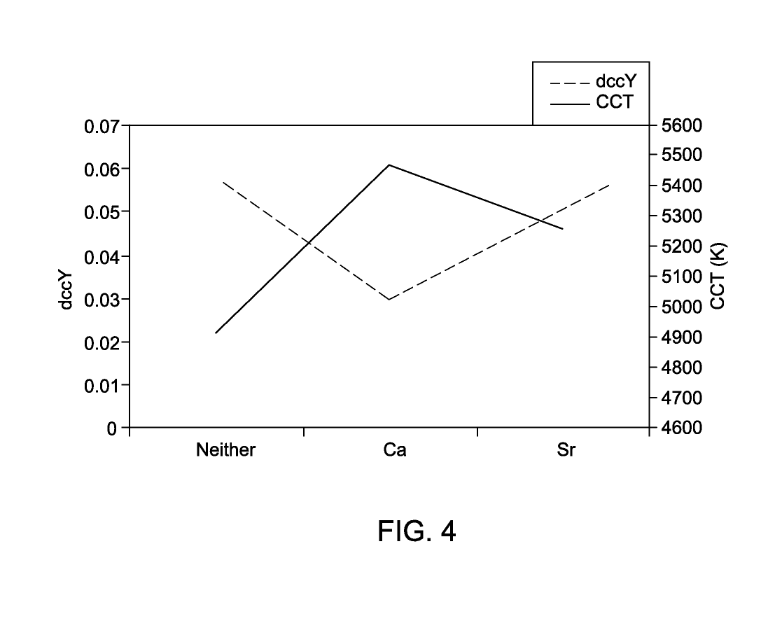

FIG. 4 is an illustrative plot of the effect of calcium and Strontium on the operational characteristics of a CMH lamp, in accordance with some embodiments herein. Referring to FIG. 4, plots the CCT for a fill with Ca, Sr, and neither Ca and Sr. As illustrated, use of the rare earths Ca and Sr yields a CCT>5000 K (e.g., about 5200 k to greater than 5400 K). This is in contrast to a fill without either that exhibits a CCT of <5200 K. FIG. 2 also shows a plot of the dCCy for the same fill compositions.

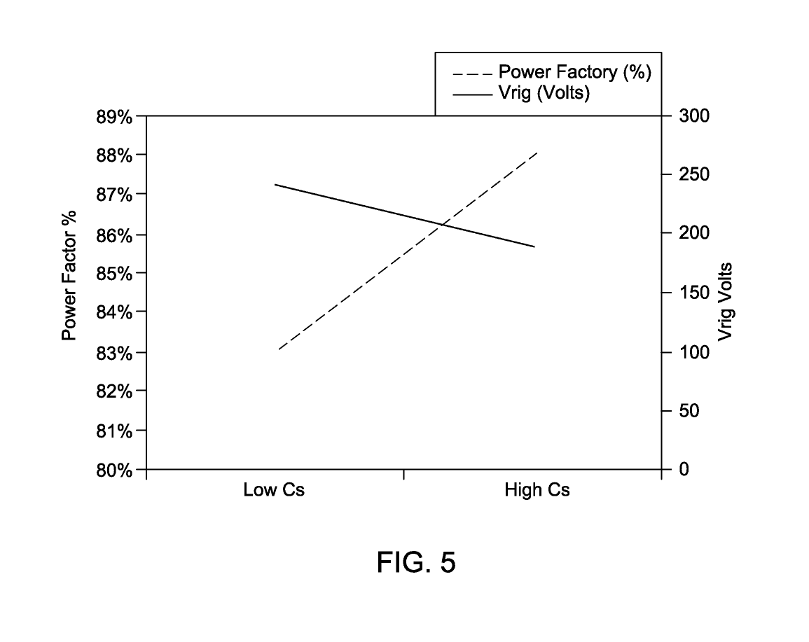

FIG. 5 is an illustrative plot of the effect of cesium (Cs) on the operational characteristics of a CMH lamp, in accordance with some embodiments herein. The cesium may be introduced to the fill in the form of, for example, CsI to increase the power factor of the lamp, as well as to reduce the reignition voltage (V_{rig}) of the lamp. Referring to FIG. 5, plots of the power factor of the lamp and the reignition voltage of the lamp for a fill including a low dose of Cs (e.g., 5%) and a high dose of Cs (e.g., 30%) are illustrated.

With respect to FIGS. 2-5, the plots are representative of some of the different materials disclosed as being valid and compatible with the various embodiments of CMH lamps herein. Accordingly, the lamp characteristics shown in the plots are exemplary examples of the different materials disclosed as being compatible herein, not a limit only to the particular materials shown in the plots.

The above description and/or the accompanying drawings are not meant to imply a fixed order or sequence of steps for any process referred to herein; rather any process may be performed in any order that is practicable, including but not limited to simultaneous performance of steps indicated as sequential.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A ceramic metal halide lamp comprising:
a discharge vessel formed of a ceramic material;
a tungsten electrode extending into the discharge vessel to energize a fill when an electric current is applied to thereto; and
an ionizable fill sealed within the discharge vessel, the fill comprising:
a buffer gas;
optionally mercury;
a halide component comprising a rare earth halide selected from the group consisting of praseodymium halides, cerium halides, lanthanum halides, neodymium halides, samarium halides, gadolinium halides, and combinations thereof that are compatible with a tungsten wall cleaning cycle;
a source of available oxygen in the discharge vessel, the available oxygen and the rare earth halide combining, during lamp operation, to achieve and maintain the tungsten wall cleaning cycle;
at least one of manganese and gallium in an amount sufficient to achieve, during lamp operation, a color rendering index (CRI) of at least 85 and a correlated color temperature (CCT) at least 5000 kelvin (K);
an amount of cesium iodide sufficient to increase the power factor of the lamp to at least 85%.
an alkaline earth metal halide in an amount to, during lamp operation and achieve a lamp life of at least 15000 hours.

2. The lamp of claim 1, wherein the lamp achieves a CRI greater than 90.

3. The lamp of claim 1, wherein the CCT of the lamp is at least 6000 K.

4. The lamp of claim 1, wherein the lumen maintenance (LM) of the lamp is at least 85%.

5. The lamp of claim 4, wherein the LM is at least 90%.

6. The lamp of claim 1, wherein the amount of cesium iodide in the fill is sufficient to reduce the re-ignition voltage to at least 180 V.

7. The lamp of claim 1, wherein the alkaline earth metal halide in the fill is operative to reduce ceramic corrosion in the lamp.

8. The lamp of claim 1, wherein the halide component comprises an alkali halide selected from the group consisting of cesium, rubidium, and potassium.

9. The lamp of claim 8, specifically excluding at least one of sodium and thallium.

10. The lamp of claim 1, wherein the halide component comprises a rare earth halide selected from gadolinium halides and optionally at least one of sodium or thallium.

11. A method of operating a ceramic metal halide lamp, the method comprising:
providing a ceramic metal halide lamp comprising:
a discharge vessel formed of a ceramic material;
a tungsten electrode extending into the discharge vessel to energize a fill when an electric current is applied to thereto;
an ionzable fill sealed within the discharge vessel, the fill comprising:
a buffer gas;
optionally mercury;
a halide component comprising a rare earth halide selected from the group consisting of praseodymium halides, cerium halides, lanthanum halides, neodymium halides, samarium halides, gadolinium halides, and combinations thereof that are compatible with a tungsten-oxygen wall cleaning cycle;
a source of available oxygen in the discharge vessel, the available oxygen and the rare earth halide combining, during lamp operation, to achieve and maintain the tungsten-oxygen wall cleaning cycle;
at least one of manganese and gallium in an amount sufficient to achieve, during lamp operation, a color rendering index (CRI) of at least 85 achieve a correlated color temperature (CCT) at least 5000 kelvin (K);
an amount of cesium iodide sufficient to increase the power factor of the lamp to at least 85%; and
an alkaline earth metal halide to, during lamp operation, increase lamp life to at least 15000 hours; and
operating the lamp by supplying an energizing current to the electrode to generate a discharge in the vessel.

12. The method of claim 11, wherein the lamp achieves a CRI greater than 90.

13. The method of claim 11, wherein the CCT of the lamp is at least 6000 K.

14. The method of claim 11, wherein the lumen maintenance (LM) of the lamp is at least 85%.

15. The method of claim 14, wherein the LM is at least 90%.

16. The method of claim 11, wherein the amount of cesium iodide in the fill is sufficient to reduce the re-ignition voltage to at least 180 V.

17. The method of claim 11, wherein the alkaline earth metal halide in the fill is operative to reduce ceramic corrosion in the lamp.

18. The method of claim 11, wherein the halide component comprises an alkali halide selected from the group consisting of cesium, rubidium, and potassium.

19. The method of claim 18, specifically excluding at least one of sodium and thallium.

20. The method of claim 11, wherein the halide component comprises a rare earth halide selected from gadolinium halides and optionally at least one of sodium or thallium.
